(19) United States
(12) Patent Application Publication
(10) Pub. No.: US 2015/0212654 A1
(43) Pub. Date: Jul. 30, 2015

(54) ARCHITECTURE FOR PROVIDING DYNAMICALLY SIZED IMAGE SEQUENCES

(71) Applicant: Comikka, Inc., Toronto (CA)

(72) Inventor: William Henry Miller Beckett, JR., Toronto (CA)

(73) Assignee: Comikka, Inc., Toronto (CA)

(21) Appl. No.: 14/166,728

(22) Filed: Jan. 28, 2014

(51) Int. Cl. G06F 3/0481; G06Q 30/02

(52) U.S. Cl. CPC G06F 3/0481; G06Q 30/0271

(57) ABSTRACT

Features are disclosed for proving a sequence of images scaled for substantially full screen presentation by browser applications executing on mobile computing devices. In some embodiments, a collection of story art images may be maintained. Each image may include a representation of a portion of a story, and the story may progress through the images in a predetermined sequence. A request from a mobile computing device for the next image in a sequence may be served with a copy of the next image in the sequence that has been scaled to the browser display area or the display size of the mobile device. Navigation features are disclosed for providing navigation operations without presentation of a visual indicator of the navigation operation.

### BACKGROUND

Mobile devices such as smart phones, tablets, media players, and the like typically have smaller displays and fewer input capabilities than desktop computers. Network-accessible content (e.g., web pages, images, videos, documents, data feeds, and other forms of electronic content) that is viewed on mobile devices is often modified to improve viewing on the smaller displays, facilitate navigation via touch screen, etc. For example, images and text may be reduced in size in order to fit on a smaller screen; the layout of content may be modified such that only a subset of total requested content is displayed, etc. In a common implementation, a content server may provide a mobile device with a version of requested content that is developed specifically for mobile devices. The content server may determine that the user is using a mobile device based on information included in the request that identifies the device or browser application as a mobile device or mobile browser (e.g., based on a “user-agent” string sent with the request).

In contrast to the general mobile browser applications typically included with mobile devices of all form factors, some content servers provide (or are compatible with) specially-developed mobile applications that target a particular type of content and/or user experience. Users typically purchase or otherwise proactively obtain such specially-developed mobile applications from, e.g., mobile application marketplaces, content provider web sites, etc. The specially-developed mobile applications can provide navigation and viewing features targeted at specific mobile devices.

### BRIEF DESCRIPTION OF DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure.

FIG. 1 illustrates a sequential image server that obtains, manages, and delivers sequences of images.

FIG. 2 illustrates interactions and data flows between a mobile device and a sequential image server facilitating the presentation of a sequence of images at the mobile device.

FIG. 3 illustrates interactions and data flows between a mobile device and a sequential image server facilitating the application of different navigation schemes based on content subject.

FIGS. 4A, 4B and 4C illustrate example navigation schemes for content received from a sequential image server.

FIG. 5A illustrates interactions and data flows between a manager device, a mobile device, and a sequential image server that may occur when a sequence of images is defined and browsed.

FIG. 5B illustrates interactions and data flows between a manager device, a mobile device, and a sequential image server that may occur when a sequence of images is modified during browsing of the images at the mobile device.

FIG. 6 illustrates a process for providing a sequence of images to a mobile device.

FIG. 7 illustrates several views of a user interface during management of image sequences.

### DETAILED DESCRIPTION OF ILLUSTRATIVE EMBODIMENTS

### Introduction

The present disclosure is directed to creating and providing sequences of images dynamically sized for full screen (or substantially full screen) display on mobile browsers. A sequence of images, such as a comic strip, graphic novel, or the like may define a story. In such cases, presentation of the story images (or “panels”) according to a specific, predetermined sequence can be critical to the proper flow and development of the story. For example, each panel may include a representation of a portion of the story, and each subsequent panel may include a representation of a subsequent portion of the story. Slide shows, collections of pictures, and other image sequences provided by conventional systems for display in browser applications (including mobile browsers) may not define a story that progresses over the course of the sequence, and therefore the sequence in which the images is presented is not critical to the proper flow and development of the story. Some specialized mobile applications are configured to present comic strips, graphic novels, and the like. However, those specialized mobile applications may not be currently installed on a user's device, may not be free, or may not otherwise be feasible for use in distributing comic strips, graphic novels, etc. to a wide array of users.

Some aspects of the present disclosure relate to providing comic panels or other story art images to mobile computing devices for full-screen display in a mobile browser application that is not related to, provided by, or otherwise associated with the provider of the story art images. For example, the mobile browser application may be a standard (general purpose) browser application that has been bundled with or otherwise previously installed on a mobile device. The comic panels can be resized by a content provider, such as a sequential image server, based on the specific resolution of the mobile device display (or viewable display area of the mobile browser). In some embodiments, the dynamic resizing is performed so as to retain the original aspect ratio of the comic panels while providing the largest version of the comic panel that can be displayed on the particular mobile device (e.g., the largest version that can be displayed without distortion caused by changing the aspect ratio, or the largest version that can be displayed without causing pixilation or some other user-perceived loss in quality). Illustratively, for a substantially square image, when a device's display is in “portrait” mode (e.g., the width of the screen is smaller than the height of the screen) the width of an image may be scaled to the width of the device's screen while the height of the image is scaled such that the aspect ratio is maintained. When the device display is in “landscape” mode (e.g., the width of the screen is larger than the height of the screen), the height of the image may be scaled to the to the screen height while the width of the image is scaled such that the aspect ratio is maintained.

The processing of comic panels by the server reduces the processing load on the mobile device and eliminates any requirement to install, on the mobile device, special application software associated with the sequential image server or other provider of such story art images. One added benefit of targeting/using standard mobile browser applications is that comic panel sequences may show up in search results, such as those received in response to a network-based search engine query. Typically such search results include links, and user activation of a link can cause the linked content to be loaded within the mobile browser without requiring another application to be launched or even installed on the mobile device. Similarly, users can send links to other users who may access the linked sequences without requiring another application to be launched or installed. The panels can be dynamically resized for full screen display on the receiving users' devices regardless of the resolution at which the panel was viewed on the sending user's device.

Additional aspects of the present disclosure relate to applying navigation configurations or schemes to sequences of panels such that the navigation scheme is invisible or does not otherwise interfere with the visual presentation of the panels. In some embodiments, the navigation configuration can be dynamically changed based on the subject of the panels. As described above and in greater detail below, panels may be presented full screen or substantially full screen. The presence of navigation controls on the screen may cover or obscure a portion of the panel, or may distract from the overall panel viewing experience. One navigation scheme that avoids such problems involves defining regions of the panel (or mobile device display) that correspond to particular navigation operations without presenting any persistent visual indicator of where the regions are or what they are for. This navigation scheme may be referred to as “invisible navigation.” When a user activates (e.g., clicks or taps) on a particular region, the navigation operation associated with the activated region (e.g., view next image, view previous image, return to main menu, etc.) can be executed. In some embodiments, different navigation schemes may be employed for different panels of a sequence based on the subject of the panel or portions thereof, rather than using the same navigation scheme for every panel. For example, a particular navigation scheme may be employed for panels of the story, and a different navigation scheme may be employed for advertisement panels that are displayed during the sequence, or for advertisements that are embedded into a story panel (e.g., product-placement advertising). As another example, some panels may include representations of subject matter that lends itself to alternative navigation schemes (e.g., a fork in the storyline, portions of the panel or objects represented in the panel for which the user can request supplemental or background information), and the like.

Further aspects of the present disclosure relate to maintaining large sequences of images (e.g., hundreds or thousands of images in a sequence) and to dynamic modification of the sequences such that the modifications are available to mobile devices in real time (or substantially in real time). In some embodiments, artists, authors, editors, story developers, and the like (collectively referred to herein as “managers” for simplicity) can manage sequences of story art images using a browser application on a computing device, such as a desktop computer. The managers can create and upload images, define sequences, rearrange images within sequences, and the like. Some sequences, such as network-accessible versions of graphic novels, may have thousands of images, and it can be difficult to manage such a large amount of images in browser application. For example, it can be difficult to move images from one portion of the sequence to another portion when the desired portion of the sequence is accessible only on another page or screen of the management interface, only after considerable scrolling or other navigation, etc. A temporary storage area, or “workspace,” can be provided so that managers can remove an image or subset of images from the sequence and temporarily hold the images outside of the sequence until a desired location within the sequence is found. Due to the visual nature of the story art images, the images themselves can remain visible in the workspace and the workspace can be persistently displayed within the browser application as the manager proceeds to scroll, access other pages or screens, perform other navigation operations, etc. When the manager has found a desired location within the sequence, the images can be removed from the workspace and inserted in the sequence. In some embodiments, modifications to image sequences (made using the workspace described above and in greater detail below, or made using other means) may be implemented in real time. For example, when a manager rearranges an image sequence, adds new images, or removes existing images, a mobile device may be currently displaying an image in the sequence. The mobile device can be provided with the next available image according to the modified sequence when the user of the mobile device choses to navigate to the next image, even though the image that is now next in the sequence may be different than when the user accessed the image currently displayed on the mobile device.

Still further aspects of the present disclosure relate to the presentation of advertising within sequences of story images. In some embodiments, advertisements may be presented at predetermined or dynamically determined intervals during the sequence (e.g., 1 advertisement for every 10 comic panels), at preselected locations within the sequence (e.g., at the end of each scene or chapter), etc. The particular advertisements that are shown may be related to the current sequence, based on user preferences for particular sequences or stories, other criteria, or some combination thereof. In some embodiments, advertisements may be embedded within a story art image. For example, a particular comic panel may display a scene of a story, and an object may be placed in the background of the depicted scene, such as a particular brand of food. Such product placements may be sold to advertisers similar to the individual advertising panels. A navigation scheme may be used which allows normal progression of the story (e.g., next panel, previous panel, etc.) in addition to obtaining information about the placed product.

Although aspects of the embodiments described in the disclosure will focus, for the purpose of illustration, on providing sequences of comic panels or graphic novel panels, one skilled in the art will appreciate that the techniques disclosed herein may be applied to any number of services, process, or applications. For example, other types of sequential images may be managed and provided to mobile devices, such as slide shows, photo albums, instructions or directions presented graphically and/or textually (e.g., driving directions, instructions for fixing something), sequential and multiple choice games (e.g., treasure hunts, sequential geocaching, games of increasing difficulty from panel-to-panel), storyboards, educational “film strips”, sheet music or text pagination, and the like. Various aspects of the disclosure will now be described with regard to certain examples and embodiments, which are intended to illustrate but not limit the disclosure.

### Networked Sequential Story

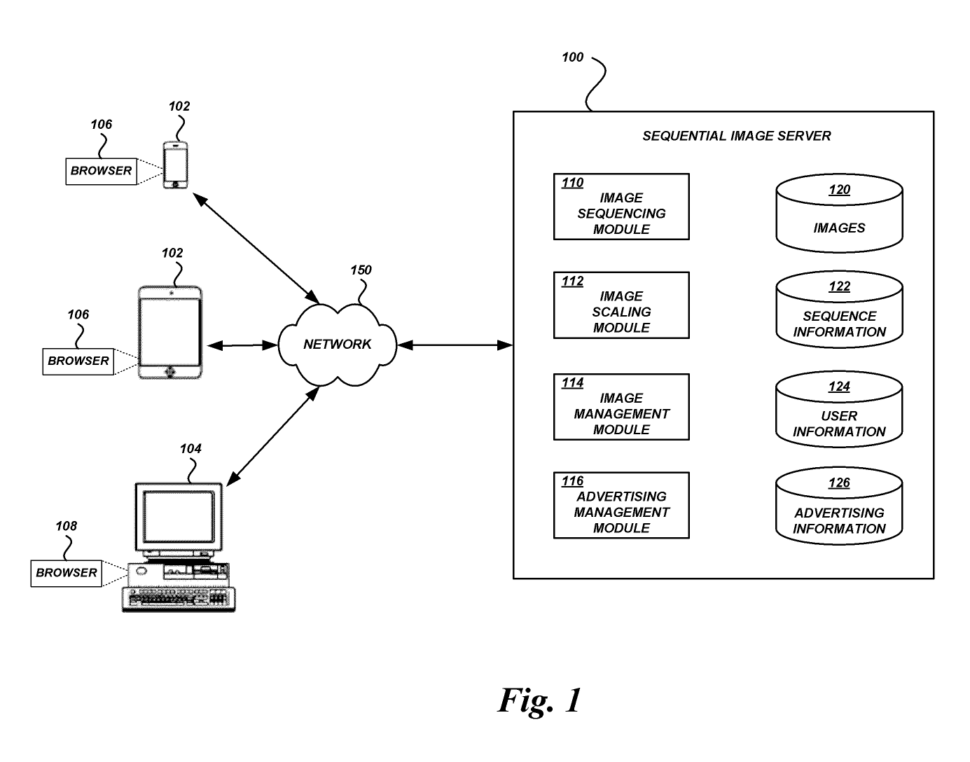

FIG. 1 shows an example sequential story image delivery environment in which features of the present disclosure can be implemented. The sequential image delivery environment may include a sequential image server 100, various mobile devices 102, and one or more manager devices 104. The various devices may communicate with each other via a communication network 150. The network 150 may be a publicly accessible network of linked networks, possibly operated by various distinct parties, such as the Internet. In other embodiments, the network 150 may include a private network, personal area network, local area network, wide area network, cable network, satellite network, cellular telephone network, etc. or combination thereof, each with access to and/or from the Internet.

The sequential image server 100 can be a computing system configured to receive, maintain, manage, and provide access to sequences of comic panels or other story art images. For example, the sequential image server 100 can be a server or group of servers that may be accessed via the network 150. The sequential image server 100 can include a number of components to provide various features, such as an image sequencing module 110 to serve comic panels in sequence to requesting mobile devices 102, an image scaling module 112 to dynamically resize comic panels for full screen presentation on mobile devices 102, an image management module 114 to facilitate management of image sequences by mangers, and an advertisement management module 116 to facilitate management of advertisements to be displayed during presentation of advertisements. The sequential image server 100 may include various data stores, such as an images data store 120 to store comic panel files that are resized for transmission to mobile devices 102, a sequence information data store 122 to store information regarding the sequence in which comic panels are to be provided to mobile devices 102, a user information data store 124 to store information about users that may facilitate selection of advertisements, and an advertising information data store 126 that can store information regarding the advertisements available for presentation to users.

The sequential image server 100 may be a single computing device, or it may include multiple distinct computing devices, such as computer servers, logically or physically grouped together to collectively operate as a server. The components of the sequential image server 100 can each be implemented as hardware, such as a server computing device, or as a combination of hardware and software. In addition, the components of sequential image server 100 can be combined on one server computing device or separated individually or into groups on several server computing devices. In some embodiments, the sequential image server 100 may include additional or fewer components than illustrated in FIG. 1.

The mobile devices 102 can correspond to a wide variety of computing devices, including mobile phones, tablet computing devices, media players, wearable computing devices (e.g., smart watches, smart eyewear, etc.), and various other mobile or personal electronic devices and appliances. The mobile devices 102 may be configured with browser applications 106 to communicate via the network 150 with other computing systems, such the sequential image server 100, and to request, receive, process, and display comic panels or other content. Illustratively, the mobile browser application 106 may be a standard browser application that is bundled with the mobile device 102 or otherwise installed on the mobile device. The mobile browser application 106 need not be related, designed for, or associated with the sequential image server 100.

The manager device 104 can correspond to a wide variety of computing devices, including personal computing devices, laptop computing devices, hand held computing devices, terminal computing devices, mobile devices (e.g., mobile phones, tablet computing devices, etc.), wireless devices, electronic readers, media players, and various other electronic devices and appliances. A manager device 104 may be configured with a browser application 108 to communicate via the network 150 with other computing systems, such the sequential image server 100 to upload comic panels, define and modify panel sequences, manage advertisements, and the like.

### Presentation of Sequential Story Images

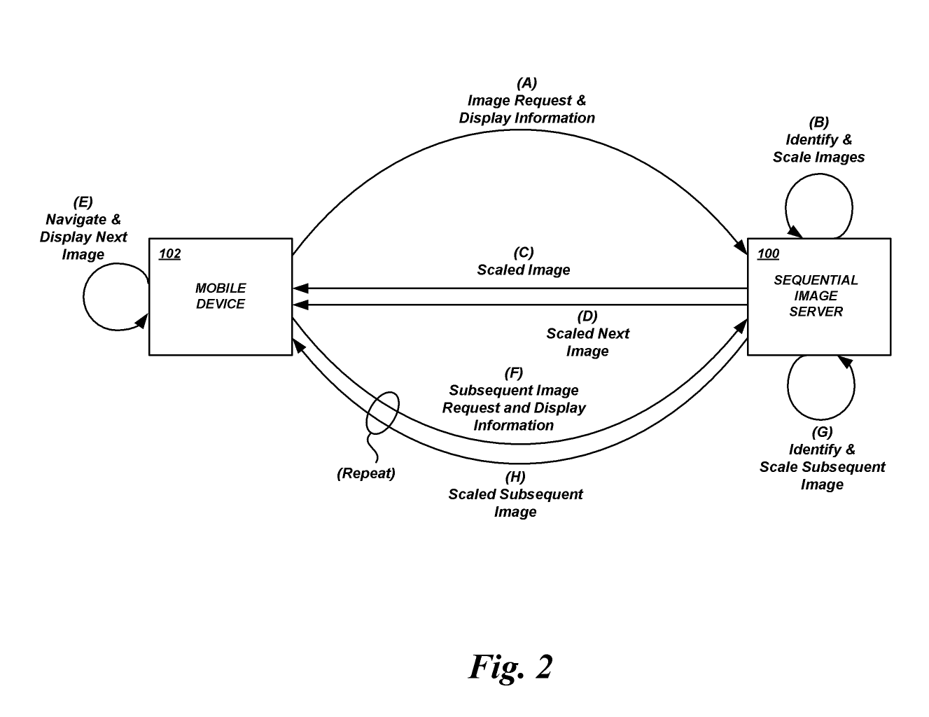

FIG. 2 shows example interactions and data flows between a mobile device 102 and a sequential image server 100 during presentation of sequence of comic panels or other story art images. A user of a mobile device 102 may use a mobile browser application 106 to request a sequence of comic panels. For example, the user may access a menu or home page provided by the sequential image server 100 that indicates which comics, graphic novels, or other sequences of story art images are available for viewing. Selecting one of the sequences can cause an image request to be sent to the sequential image server 100 at (A). The request may be a request for a sequence, for the first image of a sequence, for a particular image that is part of a sequence, or the like. For example, the request may include a network address of a requested image (e.g., a URL of a specific image). As another example, the request may include data indicating the sequence that the user would like to access (e.g., a URL with embedded parameters indicating the requested sequence) that the sequence image server 100 can use to determine the image to be sent in response.

As shown in FIG. 2, display information may also be sent to the sequential image server at (A). The display information may include information that can be used by the sequential image server 100 to provide a full screen or substantially full screen representation of a comic panel. In some embodiments, the display information may include the resolution of the display of the mobile device 102, the resolution of the display area of the mobile browser 106, an individual measurement of the width or height of the display area of the mobile device 102 or mobile browser 106, or the like. In some embodiments, the display information may include orientation information indicating whether the display of the mobile browser 106 or mobile device 106 is in portrait or landscape orientation. The display information may be provided to the sequential image server 100 prior to, in conjunction with, or subsequent to an image request. For example, the display information may be provided to the sequential image server 100 as an additional embedded parameter in a URL, along with a parameter indicating the requested sequence or image. As another example, the display information may be provided to the sequential image server 100 by executable code, such as JavaScript, that executes as a user is viewing the menu or home page described above, or in response to some other event.

At (B), the sequential image server 100 can identify the image to provide the mobile device 102 responsive to the request transmitted at (A). For example, the sequential image server 100 may access the sequence information data store 122 to determine which comic panel is the first (or next) in the sequence based on information included in the request, such as a parameter embedded in the URL, a field submitted with an HTML form, data transmitted using JavaScript, etc. The sequential image server 100 may then access the appropriate image file in the images data store 120. The file may be a high resolution image that can be scaled down to full screen resolution (or other size) indicated by the display information received at (A). The image scaling module 112 may use the image file to generate a version of the image that is scaled to a desired size. In some embodiments, the image scaling module 112 may retain the aspect ratio of the original image so as not to distort the image. In some embodiments, the image scaling module 112 may apply scaling rules that indicate how an image is to be scaled when the display of the mobile device 102 is in portrait or landscape orientation. For example, if the identified image is square or rectangular, the image scaling module 112 may automatically generate a scaled version of the image with a height that is equal to the height of display when the display is in landscape orientation, or a scaled version with a width that that is equal to the width of the display when the display is in portrait orientation.

In addition to obtaining and scaling the requested image (or the image that is responsive to the request), the sequential image server 100 can proactively obtain and scale the image that follows the requested image in the sequence. For example, the image sequencing module 110 can access the sequence information data store 122 to identify the next image in the sequence, and the image scaling module 112 can scale the image to the appropriate size, as described above with respect to the requested image. Obtaining and scaling the next image in the sequence can be performed in parallel with, or subsequent to, obtaining and scaling the requested image.

The sequential image server 100 can then transmit the scaled representation of the comic panel or other story art image to the mobile device 102 at (C). A file or stream that includes the scaled image can be transmitted to the mobile device. In some embodiments, an HTML page or other document referencing the image may be transmitted, and the mobile browser application 106 may parse and make a follow-up request to the sequential image server 100 for the image.

In some embodiments, the sequential image server 100 can also transmit the scaled representation of the next comic panel in the sequence at (D). For example, the HTML page or other document referencing the current image may also include a reference to the next image in the sequence so that the mobile device 102 can request the next comic panel and cache it locally. As another example, executable code on the mobile device 102, such as JavaScript previously provided to the mobile device 102 or provided in conjunction with the current image, may initiate retrieval of the next image in the sequence. By providing the next image in the sequent to the mobile device 102 before the user navigates to it, the image may be presented substantially immediately in response to user navigation at (E).

At (F), the mobile device 102 may transmit a request at for a subsequent image, such as the image that follows the image to which the user navigated at (E). For example, the user may have requested image #1 at (A) and received it at (C), received image #2 at (D), and navigated to image #2 at (E). The mobile browser application 106 may notify the sequential image server 100 of the navigation operation. In some embodiments, the notification may be transmitted via executable code, such as JavaScript previously provided to the mobile browser 106, in response to the user navigation operation at (E). In other embodiments, the mobile browser application 106 may initiate a request for the next image in the sequence (e.g., image #2) in response to the user navigation at (E), even though the next image has already been pre-cached. The mobile browser application 106 may proceed to display the pre-cached image. The sequential image server 100 can identify and scale the subsequent image (e.g., image #3) at (G), and provide the scaled image to the mobile device 102 at (H), similar to the processing described above.

The interactions illustrated by (E), (F), (G), and (H) may be repeated as necessary.

### Implementation of Dynamic Navigation Schemes

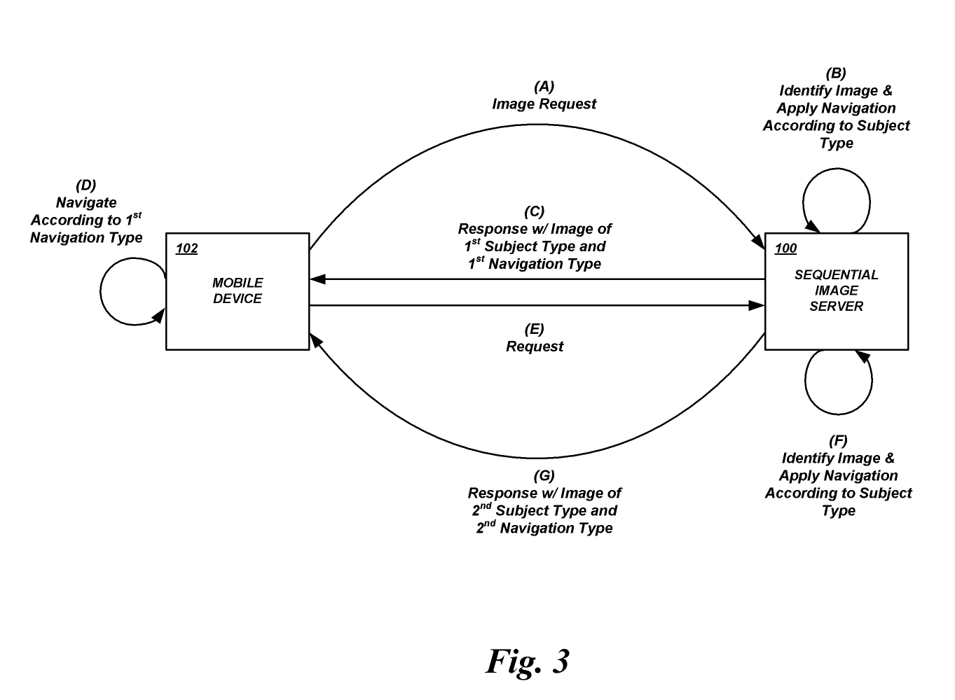

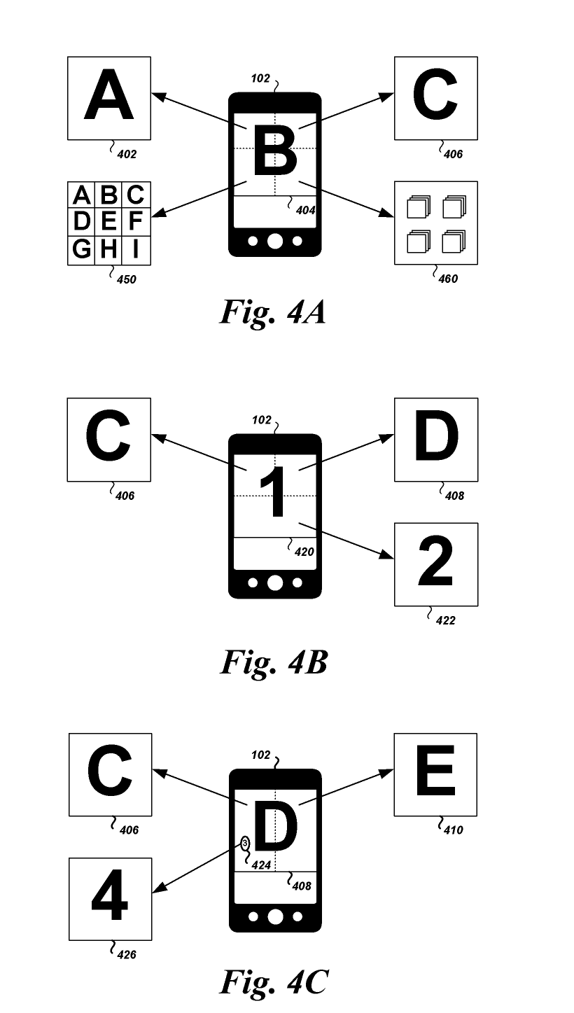

FIG. 3 shows example interactions and data flows between a mobile device 102 and a sequential image server 100 during presentation of sequence of comic panels and other images (e.g., advertisements). In particular, FIG. 3 illustrates interactions that facilitate dynamic application of multiple navigation schemes. The determination of which navigation scheme to use for a given comic panel (or other image) may be based on characteristics of the comic panel, such as the subject of the comic panel. Generally described, the subject of an image includes the content that is represented by the image or a portion of the image. For example, the content of an image may be the portion of a story that is represented in the image, the advertisement that is represented in the image, etc. FIGS. 4A-4C show example navigation schemes that may be applied during the interactions depicted in FIG. 3.

The mobile device 102 may request an image from a sequential image server 100 at (A), as described above and in greater detail below. At (B), the sequential image server 100 can identify the image to be provided to the mobile device 102 responsive to the request, scale the image to the desired size, etc. In addition, the sequential image server 100 can determine which navigation scheme to use based on, e.g., the subject of the panel. For example, if the panel is presenting a story image of a sequence, a first navigation scheme may be used, such as the navigation scheme illustrated in FIG. 4A. However, if the image is presenting an advertisement, a different navigation scheme may be used, as described below.

In FIG. 4A, a browser application 106 of a mobile device 102 is displaying a comic panel 404. Multiple navigation regions (e.g., two or more) may be defined on the panel 404, as indicated by the dashed lines. Each region may correspond to a particular navigation operation (e.g., next image, previous image). However, in some embodiments, no indicator of the regions or corresponding navigation operations may be visible. For example, there are no visible lines, buttons, arrows, text, or other visible indicators associated with navigation. Rather, the definition and boundaries of the navigation regions on the panel may be transparent. When a user activates one of the regions, a corresponding navigation operation may be performed. For example, if the user taps the upper left region, the previous panel 402 in the sequence may be presented on the mobile device 102. If the user taps the upper right region 406, the next panel in the sequence may be presented. If the lower right region is activated, a menu 460 of sequences or other options may be presented. If the lower left region is activated, a listing of all panels (or multiple panels) in the sequence may be presented.

Returning to FIG. 3, the sequential image server 100 may apply the appropriate navigation scheme to the panel. The navigation scheme may be defined by an image map, HTML elements indicating regions (e.g., <DIV> tags) corresponding to the navigation, executable code (e.g., JavaScript), or other techniques. The sequential image server 100 can then provide a response to the mobile device 102 at (C) with the image that corresponds to the request and the appropriate navigation scheme that corresponds to the subject of the image.

The user of the mobile device may perform a navigation operation at (D). For example, in the navigation scheme illustrated in FIG. 4A, the user may activate the upper right region to navigate to the next panel in the sequence. A request, navigation notification, or some other communication may be transmitted to the sequential image server at (E) as described above and in greater detail below. The sequential image server 100 can determine the appropriate panel or other image to provide the user at (F). In addition, the sequential image server 100 can determine the appropriate navigation scheme. For example, if the next image to be provided to the mobile device 102 is an advertisement rather than a subsequent story art image of the sequence, a different navigation scheme, such as the navigation scheme shown in FIG. 4B, may be chosen than would be chosen if the next image were a story art image.

In FIG. 4B, a browser application 106 of a mobile device 102 is displaying an image 420. Illustratively, the image 420 may be an advertisement. In contrast to the navigation scheme shown in FIG. 4A, a different configuration of navigation regions have been defined on the image 420. If the user taps on the upper left region, the mobile browser 106 may navigate to the previous image 406. If the user taps on the upper right region, the mobile browser 106 may navigate to the next image 408. If the user taps anywhere on the lower half of the image 420, the user may be provided with additional information about the advertisement, such as a content page 422. Although a different physical configuration of regions is displayed in FIG. 4B than 4B, in some embodiments the same configuration of regions may be used for different navigation schemes. In such cases, the navigation operation associated with one or more of the regions may be different, thereby providing the different navigation scheme.

FIG. 4C shows yet another example of a navigation scheme that may be used for various images. Illustratively, an image 408 may be displayed in a mobile browser 106. The image 408 may be a story art image, such as a comic panel, that is part of a sequence of images that make up a particular story. The image 408 may also include an object 424 associated with an advertisement. For example, the object 424 may be a paid product placement, an object that is part of the story and about which a user can obtain more information etc. Various navigation regions may be defined, such as the left side of the image corresponding to the previous image 406 in the sequence and the right side of the image corresponding to the next image 410 in the sequence. In addition, a region may be define around, adjacent, or otherwise associated with the object 424. If a user activates the region associated with the object 424, the user may be provided with additional information about the product, such as a subsequent content page 426.

The navigation schemes shown in FIGS. 4A-4C are illustrative only, and are not intended to be limiting. Generally described, a navigation scheme may include a combination of defined responses to user interactions with the content that result in additional content or information being requested by or provided to the user. Advertisements, menus, other images in the current sequence, additional information about objects included in images, forks in the storyline that result in a different sequence of images, etc. may all be presented or initiated based on user interactions with navigation schemes. The navigations schemes may include regions of “tappable” or “clickable” content, as described above, or they may include other interactive controls and methods that facilitate progression though a story or other presentation of content to a user.

Returning to FIG. 3, the sequential image server 100 may apply the appropriate navigation scheme to the image, as described above. The sequential image server 100 can then provide a response to the mobile device 102 at (G) with the image that corresponds to the request and the appropriate navigation scheme.

### Real-Time Sequence Updates

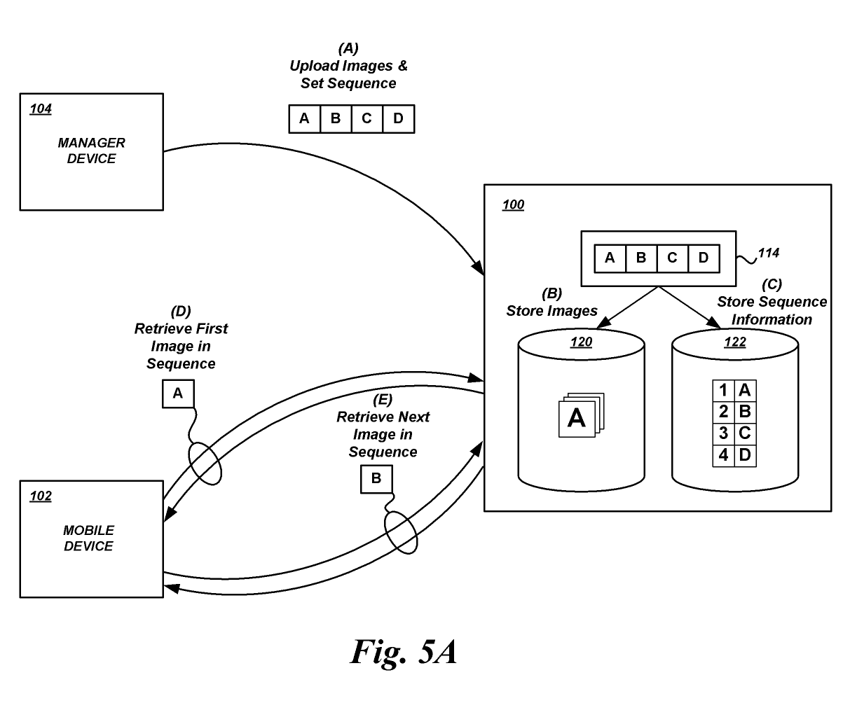

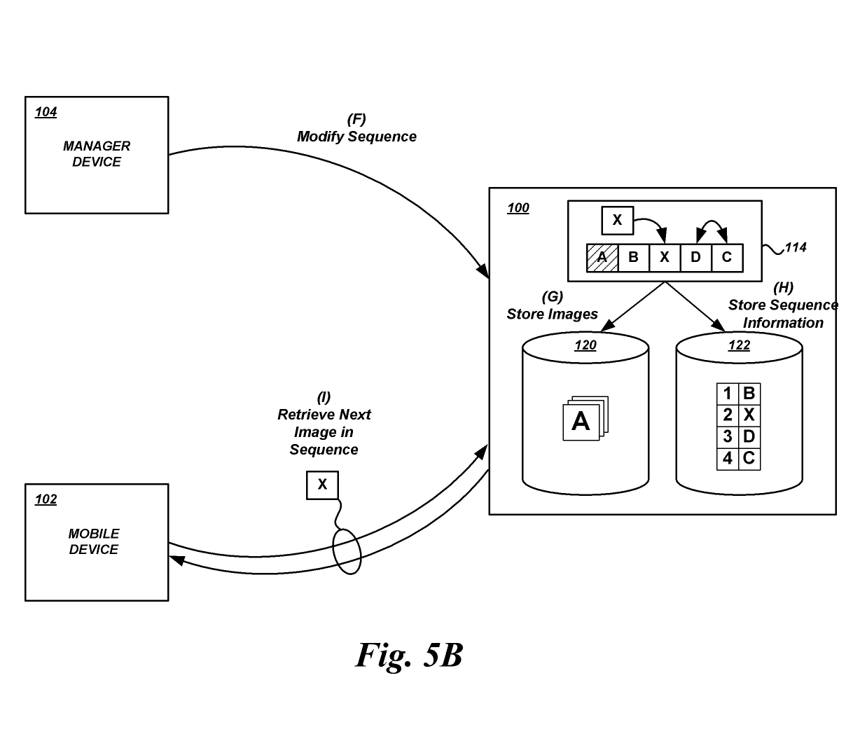

FIGS. 5A and 5B show example interactions and data flows between a manager device 104 and a sequential image server 100, and between a mobile device 102 and a sequential image server 100. In particular, FIGS. 5A and 5B illustrate interactions that may occur when a manager creates a sequence of story art images, such as a comic strip or a graphic novel. The manager may subsequently modify the sequence while a user of a mobile device is viewing the sequence in parallel. The modifications may be available in real time or substantially real time such that the user is presented with the correct next image in the sequence even if images have been added to, removed from, or moved within the sequence since the user was last provided with an image in the sequence.

A manager may use a browser application 108 of a manager 104 to define a sequence of story art images. For example, the manager may provide information about the sequence, such as a title, subject matter, user access privileges, advertising preferences (described in greater detail below), and the like. The manager may then upload one or more images to the sequential image server 100 at (A). In some embodiments, the manager may upload files (e.g., GIF, JPG, BMP, PNG, or other formats of image or graphic files) of story art images, such as high resolution versions of comic panels or graphic novel panels.

The image management module 114 may facilitate the definition of the sequence by providing user interfaces (e.g., web pages or other network-based interfaces), receiving uploaded files and data, and the like. The image management module 114 may store the received images at (B). For example, the image management module 114 may store image files in a directory structure of a file or image server, as binary objects (“BLOBs”) in a database, or using any other technique or system for storing images or files in general. The image management module 114 may also store sequence information that defines the sequence at (C). For example, the sequence information may include a listing of all images that are a part of the sequence, such as a file name, network address, or some other identifier. The sequence information may also include an index or ordinal for each image that can be used to access and provide the images in the proper sequence. Metadata or other information may be included in the sequence information, such as a sequence identifier (e.g., an identifier of the comic strip(s) or graphic novel(s) to which the images belong), creation date, edit date, version indicator, and the like. In some embodiments, sequence information may not be stored separately from the images themselves. Rather, some or all sequence information may be stored in conjunction with the images, or embedded into the images. For example, image file names may be generated based on the order in which images are to appear, the sequence to which the images apply, and the like (e.g., “1-2.jpg” where “1” indicates the particular sequence to which the image applies, and “2” indicates that the image is the second image in the sequence).

Subsequent to definition of the sequence, a user may use a mobile device 102 to view the sequence. As described in greater detail below, the user may launch a mobile browser application 104 and connect to the sequential image server 100. The user may select the sequence from a menu, home page, etc. Upon selection of the sequence, the mobile browser application 104 may be provided with the first image in the sequence at (D). The user may view the image and navigate the next image, receiving the next image at (E). As described in detail herein, in some embodiments the next image may be provided to the mobile device 102 proactively so that it can be cached on the mobile device 102.

Turning now to FIG. 5B, the manager may subsequently modify the sequence at (F). For example, the manager may remove one or more images, provide one or more new images, move one or more images around within the sequence, or the like. The image management module 114 can again store any newly created, edited, or replacement images in the image data store 120 at (G). The image management module 114 may store updated sequence information in the sequence information data store 122 at (H).

Subsequent to the modification of the sequence by the manager as described above, the user may navigate to or otherwise cause the mobile device 102 to request the next image in the sequence. For example, as shown in FIG. 5A, the mobile device 102 may be currently displaying the image labeled “B,” which was originally the second image in the sequence. As shown in FIG. 5B, the sequence has been modified such that the image labeled “B” is now the first image in the sequence, the image labeled “X” has been inserted as the second image in the sequence, and the images labeled “C” and “D” have been swapped to the fourth and third positions in the sequence, respectively. Because the image that follows “B” in the sequence is now “X,” the mobile device 102 may be provided with the “X” image at (I).

In some embodiments, the mobile device 102 may provide a request for the next image in the sequence by transmitting an index of the current and/or the next image, a file name of the current and/or next image, or other data regarding the currently displayed or requested image. For example, the mobile device may transmit a request for the image following image “B” in the current sequence, and the sequential image server 100 can determine which images follows “B,” regardless of the ordinal position in the sequence image “B” was in at the time the mobile device 102 requested it or where it is within the sequence currently. In some embodiments, the sequential image server 100 may track the most recent image provided to a given mobile device 102, all images previously provided to the mobile device 102, some subset thereof, etc. The sequential image server 100 may then determine which image to provide next based on such information.

Process for Providing a Sequence of Images with Advertisements

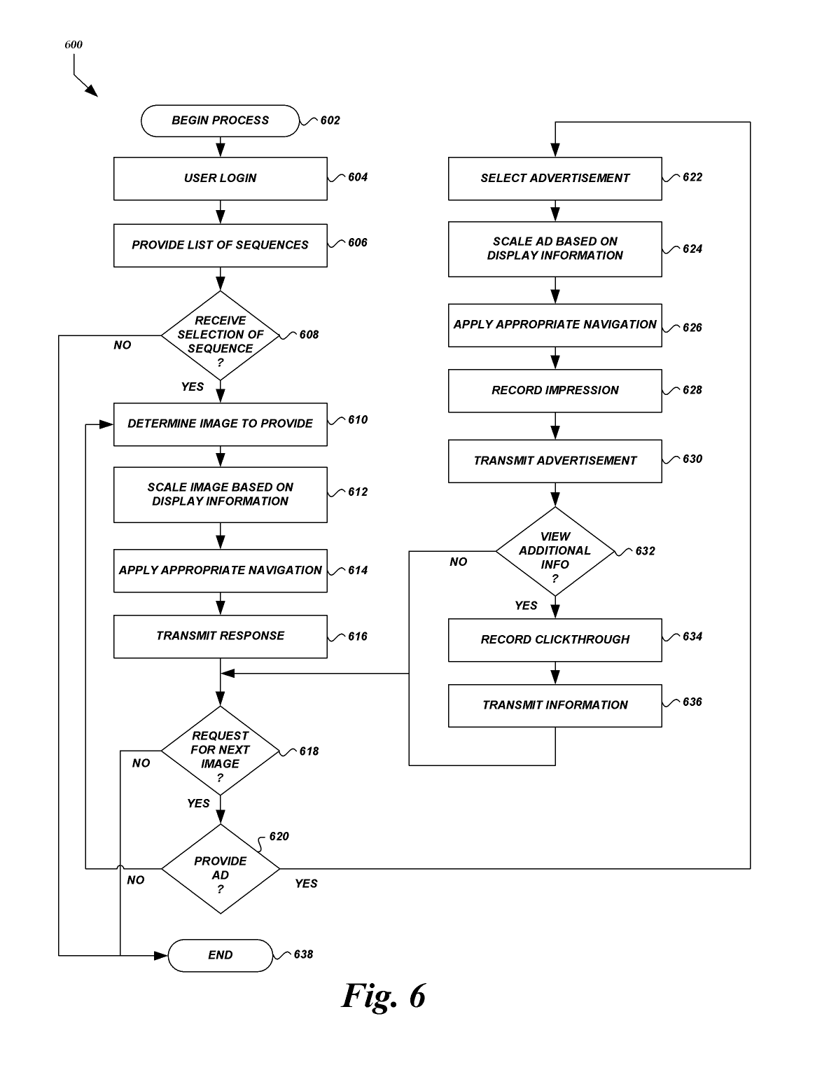

FIG. 6 illustrates a sample process 600 that may be used by a sequential image server 100 or some other computing system for responding to user requests and navigation operations, providing sequences of images, providing advertisements, and the like. Advantageously, a sequential image server may provide full-screen sequential story art images with dynamic navigation based on subject type, and also provide advertisements selected for improved advertisement performance (e.g., increased click-through rate) based on the particular comic strip or graphic novel, user characteristics, or other criteria.

The process 600 begins at block 602. For example, process 600 may begin automatically upon user initiation of a sequence browsing session. The process 600 may be embodied in a set of executable program instructions stored on non-transitory computer-readable media, such as short-term or long-term memory of one or more computing devices associated with the sequential image server 100. When the process 600 is initiated, the executable program instructions can be loaded and executed by the one or more computing devices.

At block 604, the user may log in to the sequential image server 100. Logging in can aid in selection of advertisements (described in greater detail below), providing ad-free viewing in return for payment or other considerations, resuming a position within a sequence, saving favorite sequences or artists, and the like. In some embodiments, logging in may be optional. In additional embodiments, no login feature may be used.

At block 606, the sequential image server 100 can provide a listing of available sequences. The listing may be grouped by artist, subject, creation date, edit date, or any other criteria

At decision block 608, sequential image server 100 can determine whether the user has selected a particular sequence to view. If so, the process 600 may proceed to block 610. Otherwise, the process 600 may terminate at block 638. For example, if a timeout period expires after the user login or time of initial access of the sequence listing, the process 600 may terminate.

At block 610, the image sequencing module 110 or some other module or component of the sequential image server 100 can determine the image to be provided to the mobile device 102. In some embodiments, such as when the user logs in, the most recent position accessed by user or mobile device 102 within the selected sequence may be stored at the sequential image server 100, and the next image in the sequence can be identified. In some embodiments, the mobile browser application 106 executing on the mobile device 102 may provide a cookie or other information regarding the most recent position within the selected sequence to the sequential image server 100. If the user has not previously viewed an image in the selected sequence, then the image sequencing module 110 may select the first image of the sequence.

At block 612, the image scaling module 112 or some other module or component can scale the image determined above in block 610 based on display information received from or associated with the mobile device 102, as described in greater detail above.

At block 614, the image sequencing module 110 or some other module or component can apply appropriate navigation to the image, as described in greater detail above. For example, the image sequencing module may choose between the navigation schemes illustrated in FIGS. 4A-4C. In some embodiments, a navigation scheme may be predetermined for all images in the sequence, some subset thereof. In other embodiments, the image sequencing module 110 may dynamically select the appropriate navigation scheme based on the subject of the image (e.g., based on metadata associated with the image that indicates the subject matter of the image).

At block 616, the image sequencing module 110 or some other module or component can transmit a response to the mobile device 102. The response may include a scaled representation of the story art image determined above, navigation information, and/or other information as needed.

At decision block 618, the sequential image server 100 can determine whether a subsequent request for an image in the sequence has been received. If so, the process 600 can proceed to decision block 620. Otherwise, the process 600 can terminate at block 638. For example, the sequential image server 100 can wait for a timeout period before terminating the process 600, similar to the timeout described above.

At decision block 620, the image sequencing module 110, advertising management module 116, or some other module or component can determine whether to provide an advertisement in response to the image request or image navigation operation received above. Determination of whether to provide an advertisement to a mobile device 102 may be based on an advertisement configuration. The advertisement configuration may be associated with the particular sequence being viewed, the manager or artist that developed the sequence, the subject matter of the sequence, the current user, etc. For example, a particular manager of sequences may create or select a particular advertisement configuration for all sequences managed by the manager, for some subset thereof, or on a sequence-by-sequence basis. As another example, a user may provide payment to the sequential image server 100 in return for a particular advertisement configuration (e.g., fewer advertisements than are provide to non-paying users, or no advertisements).

The advertisement configuration may include any information that can be used to determine how often to provide advertisements, which advertisements to provide, which navigation scheme to use, to which users particular advertisements should be provided, and the like. In some embodiments, the advertisement configuration may specify that an advertisement is to be presented at certain predetermined intervals (e.g., every 3rd image request) or dynamically determined intervals (e.g., based on a random number generator). The interval may be selected by, or otherwise be based on data provided by, a manager, artist, advertiser, system administrator, or the like. For example, a manager of a particular sequence may configure advertisements to be presented during the sequence at randomly determined intervals not to exceed 10 comic panels. In some embodiments, advertisements may be presented at predetermined locations within a sequence, such as when the story represented by the images reaches a scene change, new chapter, or some other triggering characteristic.

In order to support the presentation of advertisements according to the various advertisement configurations, data may be stored regarding how many images or advertisements (or which specific images or advertisements) have been provided to the current mobile device 102 over some period time. For example, data may be stored at the sequential image server 100 indicating the images and advertisements that have been provided to a particular mobile device 102 during presentation of the current sequence. As another example, the mobile device 102 may track such information (e.g., using executable code, such as JavaScript) and provide the information to the sequential image server.

If the advertising management module 116 or some other module or component determines that an advertisement is to be provided, the process 600 can proceed to block 622. Otherwise, the process 600 can return block 610, where the image sequencing module 110 or some other module or component of the sequential image server 100 determines the next image to provide.

At block 622, the advertising management module 116 or some other module or component can select the advertisement to provide to the mobile device 102. The selection may be based on the current advertisement configuration. As described above, the advertisement configuration may specify which advertisements are to be presented during current sequence, during sequences associated with the subject matter of the current sequence, to the current user, etc. For example, historical data regarding the sequences, images, subjects, and the like that the current user has viewed may be used to generate advertisement configuration information, or used directly to select particular advertisements. The advertisements may be selected based on target user profile data provided by an advertiser, historical click-through success rates for other users with similar user profile information, or based on other information. In some embodiments, managers of sequences can select specific or relative positions in the sequence for displaying advertisements. For example, a manager may wish to place an advertisement immediately following a “cliffhanger” in the sequence, at the end of the story, etc. In some embodiments, advertisements may be selected based on a user's general browsing history or favorites, a user's use of other platforms such as social media networks and search engines, a user's geographic location, the time of day, etc.

At block 624, the image scaling module 112 or some other module or component can scale the advertisement such that it can be presented full screen or substantially full screen on the mobile device 102. The scaling may be based on the display information previously obtained or determined, similar to the scaling of the story art images as described above.

At block 626, the advertising management module 116 or some other module or component can apply the appropriate navigation to the advertisement. For example, the navigation scheme may be selected based on the content of the advertisement, based on the fact that the image to be provided is an advertisement, or based on some other criteria. Application of the navigation scheme to the advertisement image may be similar to the application of a navigation scheme to any image as described herein (e.g., an image map, HTML elements, JavaScript code, etc.).

At block 628, the advertising module 116 or some other module or component can record an impression for the advertisement. Recordation of advertisement impressions may be important in order to provide proper payment to sequence managers or artists, to obtain proper payment from advertisers, to ensure advertisement agreements are fulfilled, and the like. In some embodiments, the impression may be recorded at some other time, such as after a user has initiated navigation away from the advertisement (e.g., the user has clicked or tapped a portion of the display that navigates to the next comic panel in a sequence).

At block 630, the advertisement (e.g., image and navigation information) can be transmitted to the mobile device 102. For example, the transmission may be similar in many respects to the transmission of story art images as described in detail above.

At decision block 622, the advertising management module 116 can determine whether a request to view additional information associated with the advertisement has been received. For example, if the navigation scheme shown in FIG. 4B is used, the user may have activated the region on the lower half of the advertisement. If so, the process 600 can proceed to block 634 where a “click through” or other information is recorded. Otherwise, (e.g., if the user activated the upper right region of the navigation scheme shown in FIG. 4B), the process 600 can return to decision block 618, where the sequential image server 100 determines whether a request for another image or some similar navigation operation has been performed.

At block 636, the advertising management module 116 can transmit the additional information to the mobile device. The additional information may include another image, a URL or other address to which the mobile browser 106 is to navigate, a content page provided by the advertiser for use with the advertisement image, etc. In some embodiments, the additional information may be provided such that it is opened in a separate browser tab of the mobile browser 106.

### Management of Image Sequences

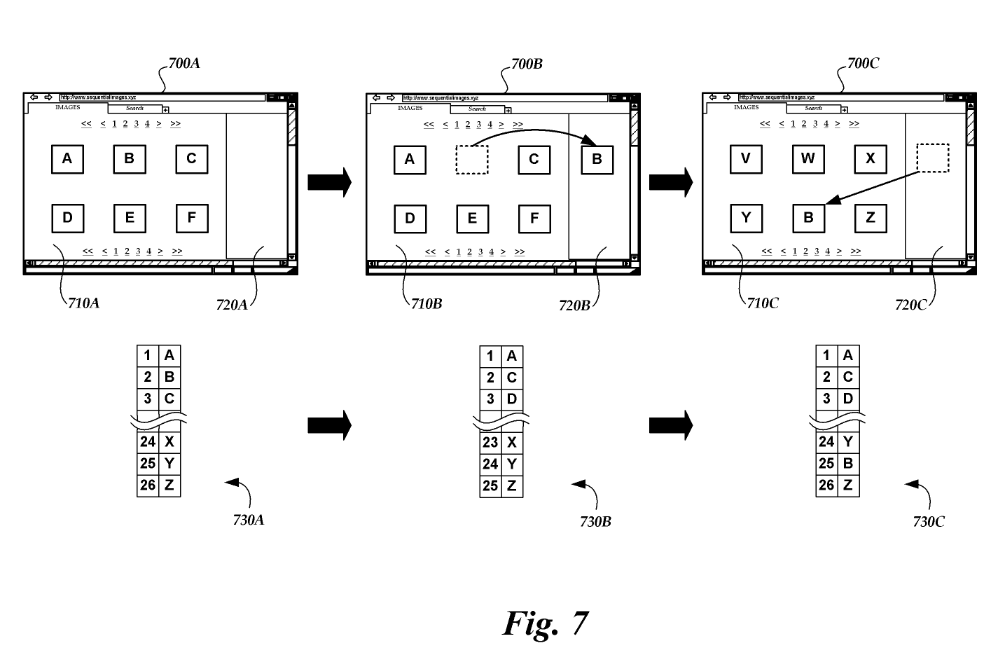

FIG. 7 shows example interactions with a sequence management interface during management of sequence of images. A manager may use the interface to move images from one portion of a sequence to another portion of a sequence, to add new images to a sequence, and the like. Some image sequences may include hundreds or thousands of individual images. In such cases, moving an image from one portion of the sequence to another portion, or adding a new image to a particular portion, can be difficult due to the large number of images in the sequence. In addition, due to the visual nature of the content, a manager will generally find it easier to identify portions of a sequence if the images (or portions thereof) are displayed. However, only a small fraction of the images may be displayed on a screen of the manager device 104 at a given time. To facilitate moving an image from one portion of a sequence to another, the image may be added to a persistent workspace that remains visible or otherwise accessible while the manager navigates to or otherwise locates the desired portion of the sequence at which to place the image. In some embodiments, the workspace described below may be a visual clipboard or other temporary storage area. The workspace may be especially useful wherever pagination is required, or in any case where the source and destination work areas are not viewable or otherwise not accessible simultaneously. In addition to moving individual images around within a sequence, the workspace may be used to move groups of images, individual artists or groups of artists, or other objects or entities around in various areas of a management interface. As another example, the workspace can be used to move individual or groups of advertisements into a sequence, thereby adding or extending drag-and-drop functionality with respect to advertisement placement. As a further example, the workspace can be used to move images from one artist to another.

Interface 700A shows an example of a sequence before an image is moved. The interface 700A may be presented in a browser application 108 executing on the manager devices. The browser application 108 may be a standard browser application 108, such as a browser application that is distributed with an operating system installed on the manager device 108 or is otherwise freely available. The interface 700A may be generated or otherwise provided by the image management module 114 or some other module or component of the sequential image server 100. For example, the interface 700A may be a web page defined by an HTML file, an HTML 5 application, JavaScript executable code, or the like.

In some embodiments, as shown, the interface 700A includes a sequence display pane 710A and a separate workspace pane 720A. The sequence display pane 710A can be used to present some or all of the images in the sequence. The display may be paginated such that a subset of the sequence images is presented, and a user must navigate or request additional pages to view additional subsets of the sequence images. In some embodiments, more images may be included in the sequence display pane 710A than can be displayed at any given time. Users may scroll to view additional portions of the sequence display pane 710A and therefore view additional sequence images. Sequence information, such as an array 730A, may be used to maintain the images and proper order of images in the sequence. The array may be maintained on the manager device 106, at the sequential image server 100, or at both systems.

Interface 700B shows removal of an image from the sequence to the workspace 720B. For example, as shown, image “B” has been removed from the sequence display pane 710B and added to the workspace 720B. In addition, the array 730B has been updated to show the removal of the image from the sequence. In some embodiments, the image may not be actually removed from the sequence when it is added to the workspace 720B. Instead, the image may be marked for removal (e.g., a visual indication of the “removal” may be applied, such as a colored outline or a dimming of the image, information in the sequence array may be added or updated, etc.). The image may also or alternatively be added to an array of images temporarily stored in the workspace 720B. When a user navigates or scrolls to a different portion of the sequence, the workspace 720B may remain displayed (e.g., as shown in interface 700C). For example, the sequence display pane 710B may be a “frame,” “iframe,” or some other container object that can be used to present and navigate content in one portion of a browser's display area, while other portions (e.g., a different iframe for the workspace) remain unchanged. As another example, the workspace 720B may be refreshed with each navigation operation, even though it appears to be persistently displayed to the user. In such cases, the identity of the images in the workspace may be proved to or otherwise determined by the sequential image server 100 so that the workspace 720B can be refreshed in response to a given navigation operation (e.g., a pagination interaction).

Interface 700C shows the addition of the image from the workspace 720C to a new location of the sequence displayed in the sequence display pane 730C. In addition, the array 730C that indicates the current images and proper order within the sequence has been updated to show image “B” at position 25, between images “Y” and “Z”. The array can be used to update or replace the sequence information for the sequence that is stored in the sequence image data store 122.

### Additional Embodiments

In some embodiments, an image may be re-sized for full screen or substantially full screen presentation (e.g., as large as possible without distortion), as described above, and other images controls may also be provided by the sequential image server for display. For example, advertisements may be displayed concurrently with the image, such as banner ads or textual ads. As another example, navigation buttons may be displayed, such as small buttons above or below the image. Other examples include controls to share a page or image with others, controls to mark a page or image as a favorite, controls to print or save a copy locally, and the like.

In some embodiments, a border or frame may be included for display around an image that is otherwise re-sized for full screen or substantially full screen presentation. For example, an image may be re-sized width-wise to about the same width as the screen of the mobile device or display area of the mobile browser. However, some room may be reserved for blank space, an outline, or some other border. In this example, re-sizing an image for substantially full screen presentation (or re-sizing based on a display size of the device or browser) includes intentionally re-sizing to some width and/or height that is less than the total width and/or height available.

In some embodiments, a sequence of images may not necessarily further the development of a story from frame to frame. Rather, the sequence of images may be a sequence of images that each relate to a different story or which otherwise do not depend on each other for development of a story. For example, the images may be single-panel comics from a single artist or associated with a single subject. The images may be presented in some intentional order, such as an order selected by an artist, even though they do not depend upon each other for development of the story from one frame to the next.

In some embodiments, the architecture described above for managing and serving sequences of images may be used in conjunction with a customized application executing on a client device, rather than a standard mobile browser. For example, a user may install and launch an application developed by, provided by, associated with, or otherwise configured to work with the sequential image server 100. The sequential image server 100 may provide images dynamically scaled for substantially full screen presentation to the application.

### TERMINOLOGY

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed or programmed to perform the functions described herein. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

1. A system for providing a sequence of comic panels to a mobile computing device, the system comprising:
computer-readable storage configured to store a plurality of comic panels, each comic panel of the plurality of comic panels comprising a visual representation of a portion of a story, wherein the story progresses through a predetermined sequence of the plurality of comic panels; and
a server comprising one or more computing devices in communication with the computer-readable storage, the server programmed to at least:
transmit, to a mobile computing device executing a browser application not provided by the system, executable code that configures the browser application to automatically determine a display area resolution of the browser application and transmit display information regarding the display area to the server;
receive, from the mobile computing device, a request for a next panel of the plurality of comic panels;
receive, from the mobile computing device, display information regarding the display area resolution of the browser application, wherein the display area resolution is automatically determined by the executable code transmitted to the mobile computing device; and
in response to the request:
identify a panel of the plurality of comic panels based at least partly on the request and the predetermined sequence;
generate a version of the panel scaled, based at least partly on the display information, for full screen presentation by the browser application; and
generate a response to the request, the response comprising the version of the panel and navigation information indicating a navigation operation associated with a region of the panel, wherein no visual indicator of the navigation operation is presented by the browser application.

2. The system of claim 1, wherein the display information is received in connection with the request.

3. The system of claim 1, wherein the display information is received separately from the request.

4. The system of claim 1, wherein the server is further programmed to at least select the navigation information based at least partly on a subject of the panel.

5. The system of claim 1, wherein the server is further programmed to at least:
receive, from the mobile computing device, a subsequent request for a next panel of the plurality of comic panels; and
identify an advertisement to provide in response to the subsequent request, the advertisement identified based at least partly on one of: the story or a user of the mobile computing device.

6. A computer-implemented method of providing a sequence of comic panels to a mobile computing device, the computer-implemented method comprising:
as implemented by a server system comprising one or more computing devices,
transmitting, to a mobile computing device executing a browser application not provided by the server system, executable code that configures the browser application to automatically determine a display area resolution of the browser application and transmit display information regarding the display area to the server system;
receiving, from the mobile browser application, a request for a next panel of a plurality of comic panels, each comic panel of the plurality of comic panels comprising a visual representation of a portion of a story, wherein the story progresses through the plurality of comic panels in a predetermined sequence;
receiving, from the mobile browser application, display information indicating a size of a display area of the mobile browser application, wherein the size of the display area is automatically determined by the executable code transmitted to the mobile computing device; and
in response to the request:
identifying a panel of the plurality of comic panels based at least partly on the request and the predetermined sequence;
generating, by the server system, a version of the panel resized based at least partly on the size of the display area; and
transmitting, to the mobile computing device, a response comprising the version of the panel.

7. The computer-implemented method of claim 6, wherein the request comprises a request for a specific panel of the plurality of comic panels, and wherein the identified panel is further identified based at least partly on information regarding a previous panel transmitted to the mobile computing device.

8. The computer-implemented method of claim 6, wherein the response further comprises navigation information indicating a navigation operation associated with a region of the panel, wherein no visual indicator of the navigation operation is presented by the browser application.

9. The computer-implemented method of claim 8, further comprising selecting the navigation information based at least partly on a subject of the panel.

10. The computer-implemented method of claim 6, the computer-implemented method further comprising:
subsequent to transmitting the response to the mobile browser application, receiving, from a second computing device separate from the mobile computing device, panel sequence information reflecting a change in the predetermined sequence, wherein a next panel of the plurality of comic panels immediately follows the panel in the predetermined sequence, and wherein the change in the predetermined sequence corresponds to assigning a different panel to immediately follow the panel in the predetermined sequence;
modifying the predetermined sequence in real time based at least partly on the panel sequence information such that the different panel immediately follows the panel;
subsequent to modifying the predetermined sequence, receiving, from the mobile browser application, a panel navigation request; and
in response to the panel navigation request:
identifying the different panel of the plurality of comic panels based at least partly on the panel navigation request and the modified predetermined sequence;
generating, by the server system, a version of the different panel resized based at least partly on the size of the display area; and
transmitting, to the mobile computing device, a second response comprising the version of the different panel.

11. The computer-implemented method of claim 6, further comprising:
generating markup code for a graphical user interface comprising:
a paginated display area configured to display (1) a first subset of the plurality of comic panels and (2) an interactive control for replacing the display of the first subset of the plurality of comic panels with display of a second subset of the plurality of comic panels; and
a persistent display area configured to display a selected panel of the first subset, wherein the persistent display area continues to display the selected panel after display of the first subset is replaced by display of the second subset; and
transmitting the markup code for the graphical user interface to an administrator computing device separate from the mobile computing device.

12. The computer-implemented method of claim 6, further comprising:
receiving, from the mobile computing device, a subsequent request for a next panel of the plurality of comic panels; and
identifying an advertisement to provide in response to the subsequent request, the advertisement identified based at least partly on the story or a user of the mobile computing device.

13. The computer-implemented method of claim 6, further comprising:
identifying, in response to the request, a second panel of the plurality of comic panels, the second panel immediately following the previously identified panel in the sequence;
generating a version of the second panel sized for full screen presentation based at least partly on the display information; and
providing the version of the second panel to the mobile communication device without receiving a request for the second panel.

14. The computer-implemented method of claim 6, further comprising:
obtaining, from a second computing device separate from the mobile computing device, sequence information regarding the sequence of comic panels; and
modifying the sequence of comic panels based at least partly on the sequence information.

15. One or more non-transitory computer storage media having stored thereon one or more modules configured to execute a process on a server system comprising one or more computing devices, the process comprising:
transmitting, to a mobile computing device executing a browser application not provided by the server system, executable code that configures the browser application to automatically determine a display area resolution of the browser application and transmit display information regarding the display area to the server system;
receiving, from the mobile browser application, a request for a next panel of a plurality of comic panels, the plurality of comic panels associated with an artist-determined sequence;
receiving, from the mobile browser application, display information indicating a size of a display area of the mobile browser application, wherein the size of the display area is automatically determined by the executable code transmitted to the mobile computing device; and
in response to the request:
identifying a panel of the plurality of comic panels based at least partly on the request and the artist-determined sequence;
generating a version of the panel resized based at least partly on the size of the display area; and
transmitting, to the mobile computing device, a response comprising the version of the panel.

16. The one or more non-transitory computer storage media of claim 15, wherein the request comprises a request for a specific panel of the plurality of comic panels, and wherein the identified panel is further identified based at least partly on information regarding a previous panel transmitted to the mobile computing device.

17. The one or more non-transitory computer storage media of claim 15, wherein the response further comprises navigation information indicating a navigation operation associated with a region of the panel, wherein no visual indicator of the navigation operation is presented by the browser application.

18. The one or more non-transitory computer storage media of claim 17, the process further comprising selecting the navigation information based at least partly on a subject of the panel.

19. The one or more non-transitory computer storage media of claim 15, the process further comprising:
generating markup code for graphical user interface comprising:
a paginated display area configured to display (1) a first subset of the plurality of comic panels and (2) an interactive control for replacing the display of the first subset of the plurality of comic panels with display of a second subset of the plurality of comic panels; and
a persistent display area configured to display a selected panel of the first subset, wherein the persistent display area continues to display the selected panel after display of the first subset is replaced by display of the second subset, and wherein the paginated display area is configured to receive insertion of the selected panel of the first subset into the second subset; and
transmitting the markup code for the graphical user interface to an administrator computing device separate from the mobile computing device.

20. The one or more non-transitory computer storage media of claim 19, the process further comprising:
receiving, from the administrator computing device, panel sequence information reflecting a change in the predetermined sequence corresponding to insertion of the selected panel of the first subset into a position within the second subset; and
modifying the predetermined sequence based at least partly on the panel sequence information.

21. The one or more non-transitory computer storage media of claim 15, the process further comprising:
receiving, from the mobile computing device, a subsequent request for a next panel of the plurality of comic panels; and
identifying an advertisement to provide in response to the subsequent request, the advertisement identified based at least partly on the plurality of comic panels or a user of the mobile computing device.

22. The one or more non-transitory computer storage media of claim 15, the process further comprising:
identifying, in response to the request, a second panel of the plurality of comic panels, the second panel immediately following the previously identified panel in the sequence;
generating a version of the second panel sized for full screen presentation based at least partly on the display information; and
providing the version of the second panel to the mobile communication device without receiving a user-initiated request for the second panel.

23. The one or more non-transitory computer storage media of claim 15, the process further comprising:
obtaining, from a second computing device separate from the mobile computing device, sequence information regarding the sequence of comic panels; and
modifying the sequence of comic panels based at least partly on the sequence information.

24. The one or more non-transitory computer storage media of claim 15, wherein the response further comprises at least one of: a visual navigation control, an advertisement, or a second image separate from the panel.
